(19) United States
(12) Patent Application Publication
(10) Pub. No.: US 2005/0233222 A1
(43) Pub. Date: Oct. 20, 2005

(54) Non-aqueous electrolyte for secondary batteries and non-aqueous electrolyte secondary batteries using the same

(76) Inventors: Katsunori Yanagida, San Diego, CA (US); Takanobu Chiga, Kobe-city (JP); Atsushi Yanai, Kobe-city (JP); Yoshinori Kida, Kobe-city (JP)

Correspondence Address: KUBOVCIK & KUBOVCIK, SUITE 710, 900 17TH STREET NW, WASHINGTON, DC, 20006, US

(21) Appl. No.: 11/077,504

(22) Filed: Mar. 11, 2005

(30) Foreign Application Priority Data
Mar. 12, 2004 (JP) 2004-071213

(51) Int. Cl. H01M 10/40; H01M 4/58

(52) U.S. Cl. 429/324; 429/231.95; 429/200

(57) ABSTRACT

Charge-discharge characteristics are improved in a non-aqueous electrolyte secondary battery including a positive electrode, a negative electrode, and a non-aqueous electrolyte containing a phosphoric ester compound as a solvent. In a non-aqueous electrolyte for secondary batteries containing a phosphoric ester compound, a lithium salt having an oxalato complex as an anion is contained as a solute. Preferably, the non-aqueous electrolyte contains lithium bis(oxalato)borate at a concentration of 0.01 to 0.2 mol/L with respect to the solvent, and more preferably, the non-aqueous electrolyte also contains vinylene carbonate.

### BACKGROUND OF THE INVENTION

1. Field of the Invention

The present invention relates to non-aqueous electrolytes for secondary batteries and non-aqueous electrolyte secondary batteries using the same. More particularly, the invention relates to a non-aqueous electrolyte for secondary batteries that uses a phosphoric ester compound as a solvent for the non-aqueous electrolyte, and a non-aqueous electrolyte secondary battery using the same.

2. Description of Related Art

Non-aqueous electrolyte secondary batteries, such as lithium secondary batteries, have a high energy density. For this reason, as the markets for mobile telephones, notebook PCs, personal digital assistants, and the like grow, the demand for non-aqueous electrolyte secondary batteries is correspondingly increasing.

The electrolyte solution used for a non-aqueous electrolyte battery is normally an electrolyte in which a lithium salt, such as LiBF₄, LiPF₆, and LiClO₄, is dissolved in an aprotic organic solvent. Examples of the aprotic solvent used are carbonates such as propylene carbonate, ethylene carbonate, diethyl carbonate, and methyl ethyl carbonate; esters such as γ-butyrolactone and methyl acetate; and ethers such as diethoxyethane.

Among these solvents, the phosphoric ester compound has self-extinguishing properties and is, therefore, one of the useful candidate substances for a solvent for non-aqueous electrolyte secondary batteries. It is expected that the use of a phosphoric ester compound makes possible an improvement in battery safety, which has been a problem in increasing a battery's energy density and producing a large-sized battery.

Nevertheless, a problem with the use of a phosphoric ester compound as a solvent for a non-aqueous electrolyte secondary battery is that the phosphoric ester compound reacts with the negative electrode during the initial charging, causing reduction and decomposition of the phosphoric ester compound. This leads to the problem of insufficient initial charge-discharge characteristics.

In order to resolve the foregoing problems, Japanese Unexamined Patent Publication No. 11-260401 proposed the addition of a vinylene carbonate derivative to the non-aqueous electrolyte. However, merely adding vinylene carbonate to a phosphoric ester compound did not inhibit the reduction of the phosphoric ester compound sufficiently and thus did not improve the charge-discharge characteristics sufficiently.

As discussed above, although the phosphoric ester compound has self-extinguishing properties and is expected to contribute to an improvement in battery safety, conventional batteries using a phosphoric ester compound as a solvent of the non-aqueous electrolyte have not achieved sufficient charge-discharge characteristics.

### BRIEF SUMMARY OF THE INVENTION

Accordingly, an object of the present invention is, with a non-aqueous electrolyte in which a phosphoric ester compound is used as a solvent of the non-aqueous electrolyte and with a non-aqueous electrolyte secondary battery using the same, to provide a non-aqueous electrolyte capable of improving battery charge-discharge characteristics when used for a non-aqueous electrolyte secondary battery and to provide a non-aqueous electrolyte secondary battery having improved charge-discharge characteristics.

A feature of the present invention is that, in a non-aqueous electrolyte for secondary batteries that contain a phosphoric ester compound, a lithium salt having an oxalato complex as an anion is contained as a solute of the non-aqueous electrolyte.

### BRIEF DESCRIPTION OF THE DRAWINGS

FIG. 1 is a schematic cross-sectional view illustrating a test battery fabricated according to one embodiment of the present invention.

### DETAILED DESCRIPTION OF PREFERRED EMBODIMENTS

According to the present invention, charge-discharge characteristics of a non-aqueous electrolyte secondary battery can be improved by adding, as a solute of the non-aqueous electrolyte, a lithium salt having an oxalato complex as an anion to a non-aqueous electrolyte containing a phosphoric ester compound. This is believed to be because, by allowing the lithium salt having an oxalato complex as an anion to be contained in the electrolyte solution, a surface film that is stable and shows high lithium ion mobility forms on the negative electrode surface.

Herein, the term “a lithium salt having an oxalato complex as an anion” means a lithium salt having an anion in which C₂O₄²⁻ coordinates to the central atom. For example, the lithium salt may be a substance represented by the chemical formula Li[M(C₂O₄)ₓR_{y}], where M is an element selected from transition metals, group IIIb elements, group IVb elements, and group Vb elements of the periodic table, R is a group selected from halogens, alkyl groups, halogen substituted alkyl groups, x is a positive integer, and y is 0 or a positive integer.

It is believed that the reduction potential of the lithium salt having an oxalato complex as an anion becomes high because of the coordination of C₂O₄²⁻, and it has a higher reduction potential than that of the phosphoric ester compound. For this reason, it is believed that, in the present invention, the lithium salt having an oxalato complex as an anion is reduced and a surface film that is stable and has high lithium ion mobility is formed on the negative electrode surface before the phosphoric ester compound reacts with the negative electrode and is decomposed. This makes it possible to inhibit the phosphoric ester compound from being reduced during the initial charging.

Preferably, in the lithium salt having an oxalato complex as an anion, the transition metal M is boron or phosphorus. Preferable examples of the lithium salt having an oxalato complex as an anion include lithium bis(oxalato)borate (Li[B (C₂O₄)₂]) lithium difluoro(oxalato)borate (Li [B(C₂O₄) F₂] lithium tetrafluoro(oxalato)phosphate (Li[P(C₂O₄) F₄]), and lithium difluorobis(oxalato)phosphate (Li[P(C₂O₄)₂E₂]). Especially preferable is Li[B (C₂O₄)₂]. The reason is that the complex in the electrolyte becomes more stable, forming a further stable surface film, and moreover, it is very advantageous in terms of cost.

Furthermore, it is preferable that another lithium salt be contained as a solute in addition to the lithium salt having an oxalato complex as an anion in the present invention. Examples of the additional lithium salt include LiPF₆, LiAsF₆, LiBF₄, LiCF₃SO₃, LiN(C₁F₂₁₊₁SO₂) (CₘF₂ₘ₊₁SO₂) (where 1 and m are integers of 1 or greater), and LiC (CₚF_{2P+1}SO₂) (C_{q}F_{2q+1}SO₂) (CᵣF₂ᵣ₊₁SO₂) (where p, q, and r are integers of 1 or greater). These solutes may be used either alone or in combination of two or more of them. It is preferable that the content of these lithium salts be 0.1 to 1.5 mol/L, and more preferably 0.5 to 1.5 mol/L, with respect to the solvent.

It is preferable that the content of the lithium salt having an oxalato complex as an anion be 0.01 to 0.2 mol/L, and more preferably 0.05 to 0.15 mol/L, with respect to the solvent. If the content is too small, the improvement in the charge-discharge characteristics, which is an advantageous effect of the present invention, may not be sufficient. On the other hand, if the content is too large, the surface film formed on the negative electrode surface becomes thick, increasing the reaction resistance of the negative electrode, and consequently, the charge-discharge characteristics may degrade.

In addition, it is preferable that in the present invention, the non-aqueous electrolyte contains a cyclic carbonic ester compound having a C═C unsaturated bond. In particular, it is preferable that the non-aqueous electrolyte be a cyclic carbonic ester having a C═C unsaturated bond, examples of which include vinylene carbonate, 4,5-dimethyl vinylene carbonate, 4,5-diethyl vinylene carbonate, 4,5-dipropyl vinylene carbonate, 4-ethyl-5-methyl vinylene carbonate, 4-ethyl-5-propyl vinylene carbonate, 4-methyl-5-propyl vinylene carbonate, vinyl ethylene carbonate, and divinyl ethylene carbonate. Among these, vinylene carbonate and vinyl ethylene carbonate are particularly desirable in that a good surface film forms on the negative electrode to suppress the decomposition of the phosphoric ester compound.

The proportion of the cyclic carbonic ester compound having a C═C unsaturated bond in the non-aqueous electrolyte is preferably 1 to 15 parts by weight, and more preferably 2 to 10 parts by weight, with respect to the electrolyte solution. If the content is too small, the improvement in the charge-discharge characteristics may not be sufficient. On the other hand, if the content is too large, the surface film formed on the negative electrode surface becomes thick, increasing the reaction resistance of the negative electrode, and consequently, the charge-discharge characteristics may degrade.

The phosphoric ester compound used in the present invention may be a chain phosphoric ester or a cyclic phosphoric ester, or may be a mixture thereof. It is particularly preferable that the phosphoric ester compound be a chain phosphoric ester that has low viscosity and good self-extinguishing properties. Specific examples include trimethyl phosphate, ethyldimethyl phosphate, diethylmethyl phosphate, triethyl phosphate, trifluoroethyldimethyl phosphate, bis(trifluoroethyl)methyl phosphate, and tris(trifluoroethyl)phosphate.

In addition to the phosphoric ester compound and the cyclic carbonic ester compound having a C═C unsaturated bond, examples of the solvent used in the present invention include cyclic carbonic esters such as ethylene carbonate, propylene carbonate, 1,2-butylene carbonate, and 2,3-butylene carbonate, as well as γ-butyrolactone and γ-valerolactone. Particularly preferable are ethylene carbonate, propylene carbonate, γ-butyrolactone, and mixed solvents thereof. Furthermore, the non-aqueous solvents generally used for batteries may also be used, such as methyl acetate, ethyl acetate, propyl acetate, methyl propionate, ethyl propionate, tetrahydrofuran, 2-methyltetrahydrofuran, 1,4-dioxane, 1,2-dimethoxyethane, 1,2-diethoxyethane, acetonitrile, dimethylformamide, and the like.

A non-aqueous electrolyte secondary battery of the present invention comprises a positive electrode, a negative electrode, and a non-aqueous electrolyte for secondary batteries that contains a phosphoric ester compound, and is characterized in that a lithium salt having an oxalato complex as an anion is contained as a solute of the non-aqueous electrolyte.

The negative electrode used in the present invention is not particularly limited as long as it comprises a material that is capable of intercalating and deintercalating lithium. However, the use of a carbon material is preferable from the viewpoint that a good quality surface film can form on the surface thereof in a non-aqueous electrolyte containing a phosphoric ester compound.

A carbon material having an R_{A} value (I_{A}/I_{G}) of 0.05 to 0.40 as measured by Raman spectroscopy is particularly preferable since such a carbon material offers good charge-discharge characteristics. The R_{A} value (I_{A}/I_{G}) is calculated by separating a peak P_{D} in the vicinity of 1360 cm⁻¹ obtained by a laser Raman spectroscopy measurement using an argon ion laser having a wavelength of 514.5 nm into a broad peak P_{A} having a half-width of 100 cm⁻¹ or greater and a peak P_{B} having a half-width of less than 100 cm⁻¹, and obtaining a ratio of the peak intensity (I_{A}) of the broad peak PA having a half-width of 100 cm⁻¹ or greater to the peak intensity (I_{G}) of a peak P_{G} in the vicinity of 1580 cm⁻¹. The peak in the vicinity of 1580 cm⁻¹ originates from a layered structure having a hexagonal symmetry similar to the graphite structure, and the peak in the vicinity of 1360 cm⁻¹ originates from a disordered amorphous structure in a local portion of carbon. The broad peak PA having a half-width of 100 cm⁻¹ or greater is normally determined to be at a position in the vicinity of 1380 cm⁻¹ according to the Gaussian function, and the peak P_{B} having a half-width of less than 100 cm⁻¹ is normally determined to be at a position in the vicinity of 1350 cm⁻¹ according to the Lorentz function. Here, the peak PA originates from amorphous carbon, so that when the proportion of amorphous portion of the carbon material within the surface layer is greater, the R_{A} value (I_{A}/I_{G}) becomes greater. When the crystallinity of the carbon material in the surface is low, a surface film that is more uniform and dense will form. Therefore, when the R_{A} value (I_{A}/I_{G}) obtained by Raman spectroscopy is 0.05 or greater, a surface film that is dense and uniform and has high lithium ion mobility forms, suppressing the decomposition of the phosphoric ester compound and providing good discharge characteristics. When the R_{A} value (I_{A}/I_{G}) becomes greater than 0.4, the surface is put into a very amorphous condition, and the charge-discharge efficiency may degrade. Therefore, it is preferable that the R_{A} value (I_{A}/I_{G}) be within the range of from 0.05 to 0.4, and more preferably within the range of from 0.05 to 0.25.

As for the foregoing carbon material, ones having an R value (I_{D}/I_{G}) of 0.2 to 0.8 of as measured by Raman spectroscopy are particularly preferable since such carbon materials offer good charge-discharge characteristics. The R value (I_{D}/I_{G}) is calculated as the ratio of the peak intensity (I_{D}) of the peak PD in the vicinity of 1360 cm⁻¹ to the peak intensity (I_{G}) of the peak PG in the vicinity of 1580 cm⁻¹, as measured by laser Raman spectroscopy using an argon ion laser having a wavelength of 514.5 nm. The peak in the vicinity of 1580 cm⁻¹ originates from a layered structure having a hexagonal symmetry similar to a graphite structure. The peak in the vicinity of 1360 cm⁻¹ originates from the disorder in the graphite layer. Accordingly, the R value (I_{D}/I_{G}) becomes greater when the proportion of the amorphous portion in the surface layer of the carbon material is greater. When the crystallinity of the carbon material in the surface is low, a surface film that is more uniform and dense is formed, and the negative electrode/electrolyte solution interface becomes stable and has high lithium ion mobility, suppressing the reductive decomposition of the phosphoric ester compound. Therefore, when the R value (I_{D}/I_{G}) obtained by Raman spectroscopy is 0.2 or greater, good discharge characteristics can be obtained. Conversely, when the R value (I_{D}/I_{G}) becomes greater than 0.8, the surface is put into a very amorphous condition and there is a risk of causing a reduction in charge-discharge efficiency. Therefore, it is preferable that the R value (I_{D}/I_{G}) be within the range of from 0.2 to 0.8, and more preferably, within the range of 0.2 to 0.5.

The carbon material having a R_{A} value (I_{A}/I_{G}) of 0.05 to 0.40 may be a carbon composite material comprising a first carbon material that forms a core material and a second carbon material that covers a portion or the entirety of the surface thereof. The second carbon material is a carbon material having lower crystallinity than that of the first carbon material. Covering a portion or the entirety of the graphite surface with the second carbon material with lower crystallinity makes it possible to control the crystallinity of the carbon material surface, and consequently achieves a non-aqueous electrolyte secondary battery with good discharge characteristics.

The carbon composite material may be synthesized by, for example, mixing a carbon material that forms the core material with a carbonizable organic compound and then sintering the mixture, or may be produced by a method in which a vapor of an organic compound is introduced onto a carbon material that forms a core material for a certain duration under a high temperature condition (a CVD method).

Examples of the organic compound that is to be mixed and sintered to produce a carbon composite material include pitch and tar, as well as phenol-formaldehyde resin, furfuryl alcohol resin, carbon black, vinylidene chloride, and cellulose. These organic compounds may be used by dissolving them into an organic solvent such as methanol, ethanol, benzene, acetone, and toluene. The carbon composite material can be produced as follows. Into the solution of an organic compound, a carbon material that forms a core material is immersed and then taken out of the solution. Thereafter, the organic compound that has attached to the surface is carbonized in an inert atmosphere at 500° C. to 1800° C., or more preferably, at 700° C. to 1400° C.

Examples of the organic compound that can be used for the CVD method include hydrocarbons such as methane, ethane, propane, butane, ethylene, propylene, butene, benzene, toluene, ethyl benzene, cyclohexane, and cyclopentene, and derivatives thereof. An organic compound is heated and vaporized, and using nitrogen or an inert gas as a carrier, the vaporized organic compound is introduced into a reaction chamber in which a carbon material that serves as a core material has been accommodated. Thus, the carbon composite material can be produced. The process temperature for the carbon material that serves as a core material is preferably from 500° C. to 1800° C., and more preferably from 700° C. to 1400° C.

Among the carbon materials usable for the negative electrode active material, graphite materials are particularly preferable. Preferable graphite materials are those in which the interlayer spacing (d₀₀₂) of the (002) plane as obtained by X-ray diffraction is within the range of 0.335 to 0.338 nm, and the crystallite size in the c-axis direction (L_{c}) is 30 nm or greater. More preferable are those having an interlayer spacing (d₀₀₂) of from 0.335 to 0.336 nm and a crystallite size (L_{c}) of 100 nm or greater. The use of such carbon materials makes it possible to attain a battery having a high discharge capacity.

It is preferable that with the above-described carbon material, the ratio (I₁₁₀/I₀₀₂) of the peak intensity (I₀₀₂) of the (002) plane and the peak intensity (I₁₁₀) of the (110) plane as measured by X-ray diffraction be within the range of from 5×10⁻³ to 1.5×10⁻². When the ratio (I₁₁₀/I₀₀₂) is within this range, the high rate discharge performance can be improved.

The above-described carbon material is kneaded with a binder agent such as polytetrafluoroethylene (PTFE), poly(vinylidene fluoride) (PVDF), and styrene-butadiene rubber (SBR) according to common methods, and is used as a mixture.

The positive electrode active material used in the present invention is not particularly limited as long as it is usable as a positive electrode active material for non-aqueous electrolyte secondary batteries. For example, lithium-containing transition metal oxides may be used, such as lithium-cobalt oxide (LiCoO₂), lithium-nickel oxide (LiNiO₂), and lithium-manganese oxide (LiMn₂O₄). These materials may be used as a mixture by mixing them with a conductive agent, such as acetylene black or carbon black, and a binder agent, such as polytetrafluoroethylene (PTFE) or poly(vinylidene fluoride) (PVDF).

In the present invention, in order to improve the wettability to the separator, it is preferable that a surfactant such as trioctyl phosphate or an ester having a large molecular weight be added to the non-aqueous electrolyte. A preferable addition amount is about 0.5 to 5 parts by weight with respect to 100 parts by weight of the non-aqueous electrolyte.

In addition to the positive electrode active material, the negative electrode active material, and the non-aqueous electrolyte as described above, a non-aqueous electrolyte secondary battery according to the present invention comprises members for constructing a battery, such as a separator, a battery case, a current collector serving to retain an active material and to perform current collection, and so forth. Such components are not particularly limited, and various members may be used including known components.

In addition, it is preferable that, in the manufacturing step for fabricating the non-aqueous electrolyte secondary battery according to the present invention, the initial charging be performed at a current value of a 10 hour rate (0.1 It) or less after filling the electrolyte solution. If the initial charge current is greater than a 10 hour rate, good discharge characteristics may not be obtained because the formation of the surface film may not occur uniformly during the initial charging and consequently the decomposition of the phosphoric ester compound will be promoted. In addition, in this initial charging, it is preferable that 10% or more of the battery capacity is charged with a current of a 10 hour rate during an early stage in the initial charging, and then, after that early stage of the initial charging, charging is performed with a current of greater than a 10 hour rate.

According to the present invention, charge-discharge characteristics of a non-aqueous electrolyte secondary battery can be improved when using a non-aqueous electrolyte containing a phosphoric ester compound as the electrolyte for the secondary battery.

### EXAMPLES

Hereinbelow, the present invention is described in further detail by way of examples. It should be construed, however, that the present invention is not limited to the following examples but various changes and modifications are possible without departing from the scope of the invention.

### Example 1

Preparation of Working Electrode

Graphite powder (d₀₀₂=0.336 nm, L_{c}>100 nm) was placed in a reaction chamber, and while keeping the inside of the chamber at 1000° C., ethylene vapor was supplied using nitrogen as a carrier gas so as to cause a reaction. Thus, the surface of the graphite powder was covered with amorphous carbon. Using a Raman spectrometer (T-64000 made by Horiba Ltd.), the graphite powder was irradiated with argon ion laser having a wavelength 514.5 nm to measure the Raman spectra, the peak intensity (I_{G}) in the vicinity of 1580 cm⁻¹ and the peak intensity (I_{D}) in the vicinity of 1360 cm⁻¹ were obtained. The R value (I_{D}/I_{G}) of the graphite powder was found to be 0.21. The R_{A} value (I_{A}/I_{G}) was calculated by separating the peak P_{D} in the vicinity of 1360 cm⁻¹ obtained by a laser Raman spectroscopy measurement using argon ion laser having a wavelength of 514.5 nm into a broad peak PA having a half-width of 100 cm⁻¹ or greater and a peak P_{B} having a half-width of less than 100 cm⁻¹, and obtaining a ratio of the peak intensity (I_{A}) of the broad peak P_{A} having a half-width of 100 cm⁻¹ or greater to the peak intensity (I_{G}) of the peak P_{G} in the vicinity of 1580 cm⁻¹. The R_{A} value (I_{A}/I_{G}) thereof was 0.07. A broad peak P_{A} having a half-width of 100 cm⁻¹ or greater was determined to be at the peak position 1380 cm⁻¹ according to the Gaussian function, while a peak P_{B} having a half-width of less than 100 cm⁻¹ was determined to be at the peak position 1350 cm⁻¹ according to the Lorentz function. Using this graphite as a negative electrode active material, 97.5 parts by weight of the negative electrode active material, 1 part by weight of styrene-butadiene rubber (SBR), and 1.5 parts by weight of carboxymethylcellulose (CMC) were mixed to prepare a negative electrode mixture, which was then dispersed into water to prepare a slurry. The slurry was applied onto one side of a copper foil, then dried and rolled. The rolled material was cut into a circular plate having a diameter of 20 mm and used as a working electrode.

Preparation of Counter Electrode

A counter electrode was prepared by stamping out a circular plate having a diameter of 20 mm from a rolled lithium plate having a predetermined thickness.

Preparation of Electrolyte Solution

Lithium tetrafluoroborate (LiBF₄) and lithium bis(oxalato)borate (Li[B(C₂O₄)₂]) were dissolved as solutes at concentrations of 1.2 mol/L and 0.1 mol/L, respectively, into a mixed solvent of trimethyl phosphate (TMP) and γ-butyrolactone (GBL) (volume ratio TMP:GBL=50:50). To 100 parts by weight of the non-aqueous electrolyte solution thus prepared, 5 parts by weight of vinylene carbonate (VC) and 5 parts by weight of trioctyl phosphate (TOP) were added to prepare a non-aqueous electrolyte solution.

Preparation of Test Battery

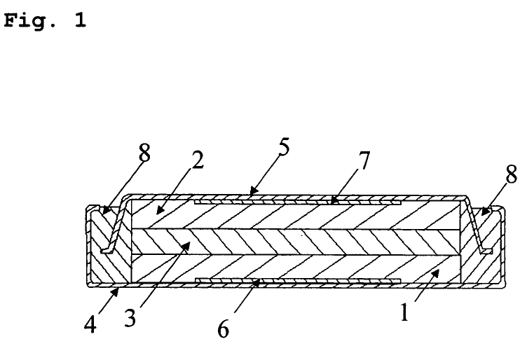

Using the working electrode, the counter electrode, and the electrolyte solution as described above, a flat-shaped test battery A1 according to the present invention (battery dimensions: diameter 24.0 mm and thickness 3.0 mm) was fabricated. FIG. 1 illustrates a test battery thus fabricated. As illustrated in FIG. 1, the working electrode 1 and the counter electrode 2 are placed so as to oppose each other with a separator 3 interposed therebetween, and these components are accommodated in a battery case comprising a working electrode-side current battery can 4 and a counter electrode-side battery can 5. The counter electrode 2 is connected to the counter electrode-side battery can 5 via a counter electrode-side current collector plate 7. The working electrode 1 is connected to the working electrode-side current battery can 4 via a working electrode-side current collector plate 6. The outer periphery of the counter electrode-side battery can 5 is fitted into the working electrode-side current battery can 4 with an insulative packing 8 placed therebetween. As the separator 3, a microporous film made of polyethylene is used, and the above-described non-aqueous electrolyte is impregnated into the separator 3.

The above-described test battery was constructed for the purpose of evaluating the charge-discharge characteristics of the negative electrode and the electrolyte solution according to the present invention. Accordingly, when electric current is passed in the direction in which the working electrode is electrochemically discharged, lithium ions are intercalated into the negative electrode, which is the working electrode, and the battery is charged. Conversely, when electric current is passed in the direction in which the working electrode is electrochemically charged, lithium ions are deintercalated from the negative electrode, which is the working electrode, and the battery is discharged. This test battery is configured with a large excess of metallic lithium in terms of electric capacity, and with this test battery, it is possible to evaluate the characteristics of the negative electrode and the electrolyte solution.

### Comparative Example 1

A comparative test battery X1 was prepared in the same manner as in Example 1 except that lithium tetrafluoroborate (LiBF₄) alone was dissolved as a solute into the solvent at a concentration of 1.2 mol/L.

### Example 2

A test battery X2 according to the present invention was prepared in the same manner as in Example 1 except that a mixed solvent of triethyl phosphate (TEP) and γ-butyrolactone (GBL) (volume ratio TMP:GBL=50:50) was used.

### Comparative Example 2

A comparative test battery X2 was prepared in the same manner as in Example 1 except that a mixed solvent of triethyl phosphate (TEP) and γ-butyrolactone (GBL) (volume ratio TMP:GBL=50:50) was used and lithium tetrafluoroborate (LiBF₄) alone was dissolved as a solute into the solvent at a concentration of 1.2 mol/L.

### Comparative Example 3

A comparative test battery X3 was prepared in the same manner as in Example 1 except that a sole solvent of γ-butyrolactone (GBL) was used as the solvent.

### Comparative Example 4

A comparative test battery X3 was prepared in the same manner as in Example 1 except that a sole solvent of γ-butyrolactone (GBL) was used as the solvent and lithium tetrafluoroborate (LiBF₄) alone was dissolved as a solute into the solvent at a concentration of 1.2 mol/L.

Evaluation of the Batteries

With each of the test batteries A1 and A2 and comparative test batteries X1 to X4, the negative electrode was charged (electrochemically discharged) at a current density of 0.5 mA/cm² to an end voltage of 0.0 V. Further, the negative electrode was charged at a current density of 0.1 mA/cm² (end voltage 0.0V) Then, the negative electrode was discharged (electrochemically charged) with a constant current at a current density of 0.25 mA/cm² to 1.0 V. Thus, the charge-discharge characteristics of the negative electrode were measured. Table 1 shows the initial charge capacity, the initial discharge capacity, and the initial charge-discharge efficiency of each of the test batteries.

TABLE 1

| | | | | | Charge- |
|---|---|---|---|---|---|
| | | | Charge | Discharge | discharge |
| | | | capacity | capacity | efficiency |
| Battery | Solute | Solvent | (mAh/g) | (mAh/g) | (%) |
| A1 | LiBF₄/ | TMP/GBL | 540 | 250 | 46.3 |
| | Li[B(C₂O₄)₂] | | | | |
| X1 | LiBF₄ | TMP/GBL | 450 | 162 | 36.0 |
| A2 | LiBF₄/ | TEP/GBL | 400 | 310 | 77.5 |
| | Li[B(C₂O₄)₂] | | | | |
| X2 | LiBF₄ | TEP/GBL | 414 | 300 | 72.5 |
| X3 | LiBF₄/ | GBL | 375 | 356 | 94.9 |
| | Li[B(C₂O₄)₂] | | | | |
| X4 | LIBF₄ | GBL | 372 | 352 | 94.9 |

The results shown in Table 1 clearly demonstrate that the test battery A1 according to the present invention exhibits a greater discharge capacity and a higher initial charge-discharge efficiency than those of the comparative test battery X1. Moreover, the test battery A2 according to the present invention exhibits a greater discharge capacity and a higher initial charge-discharge efficiency than those of the comparative test battery X2. This is believed to be attributable to the following; by using, as a solute of the non-aqueous electrolyte containing a phosphoric ester compound, the lithium salt having an oxalato complex as an anion, a good quality surface film having high lithium ion mobility was formed on the negative electrode surface, and the charge-discharge characteristics were thus improved.

In the test batteries A1 and A2 according to the present invention, lithium bis(oxalato)borate, which has a reduction potential of about 1.6 to 1.7V, was used as a solute. Therefore, a good quality surface film with high lithium ion mobility was formed on the surface of the negative electrode before the phosphoric ester compound, which has a reduction potential of about 1 V, is reduced. It is believed that as a result of this, the decomposition of the phosphoric ester compound was suppressed and the charge-discharge efficiency was improved.

Each of the comparative evaluation batteries X1 and X2 did not contain lithium bis(oxalato)borate in the electrolyte solution, but VC was added thereto. The reduction potential of VC is about 0.9 V. Accordingly, it is believed that the reduction of the phosphoric ester compound, which has a reduction potential of about 1 V, started to take place before VC reacts with the negative electrode and a good quality surface film forms on the negative electrode surface, and as a consequence, the initial charge-discharge efficiencies of these batteries became lower than those of the batteries A1 and A2, which contained lithium bis(oxalato)borate in their electrolyte solution.

The comparative test batteries X3 and X4, which used the non-aqueous electrolytes that do not contain a phosphoric ester compound, did not show an improvement in the charge-discharge efficiency although the comparative test battery X3 used the lithium salt having an oxalato complex as an anion as the solute.

In the foregoing examples, although the test batteries were prepared to evaluate the electrolyte solutions, the present invention can be applied to a wide variety of non-aqueous electrolyte secondary batteries. For example, the same advantageous effects are obtained also with so-called rocking chair-type non-aqueous electrolyte secondary batteries, which use lithium-cobalt oxide (LiCoO₂), lithium-nickel oxide (LiNiO₂), lithium-manganese oxide (LiMn₂O₄), and the like as the positive electrode active material. Moreover, the shape of the battery is not particularly limited, and the invention is applicable to non-aqueous electrolyte secondary batteries of various shapes, such as cylindrical, prismatic, or flat shape.

Only selected embodiments have been chosen to illustrate the present invention. To those skilled in the art, however, it will be apparent from the foregoing disclosure that various changes and modifications can be made herein without departing from the scope of the invention as defined in the appended claims. Furthermore, the foregoing description of the embodiments according to the present invention is provided for illustration only, and not for limiting the invention as defined by the appended claims and their equivalents.

1. A non-aqueous electrolyte for secondary batteries, comprising a phosphoric ester compound and, as a solute of the non-aqueous electrolyte, a lithium salt having an oxalato complex as an anion.

2. The non-aqueous electrolyte for secondary batteries according to claim 1, wherein the lithium salt having an oxalato complex as an anion is represented by the chemical formula Li[M(C₂O₄)ₓR_{y}], where M is an element selected from transition metals, group IIIb elements, group IVb elements, and group Vb elements of the periodic table, R is a group selected from halogens, alkyl groups, and halogen-substituted alkyl groups, x is a positive integer, and y is 0 or a positive integer.

3. The non-aqueous electrolyte for secondary batteries according to claim 2, wherein, in the lithium salt having an oxalato complex as an anion, the transition metal M is boron or phosphorus.

4. The non-aqueous electrolyte for secondary batteries according to claim 1, wherein the lithium salt having an oxalato complex as an anion is lithium bis(oxalato)borate (Li[B(C₂O₄)₂]).

5. The non-aqueous electrolyte for secondary batteries according to claim 1, wherein another lithium salt is contained as the solute in the non-aqueous electrolyte in addition to the lithium salt having an oxalato complex as an anion.

6. The non-aqueous electrolyte for secondary batteries according to claim 1, wherein the non-aqueous electrolyte contains vinylene carbonate.

7. A non-aqueous electrolyte for secondary batteries, comprising a phosphoric ester compound and, as a solute of the non-aqueous electrolyte, a lithium salt having an oxalato complex as an anion, wherein the lithium salt having an oxalato complex as an anion is contained at a concentration of 0.01 to 0.2 mol/L with respect to the solvent.

8. The non-aqueous electrolyte for secondary batteries according to claim 7, wherein the lithium salt having an oxalato complex as an anion is represented by the chemical formula Li[M(C₂O₄)ₓR_{y}], where M is an element selected from transition metals, group IIIb elements, group IVb elements, and group Vb elements of the periodic table, R is a group selected from halogens, alkyl groups, and halogen-substituted alkyl groups, x is a positive integer, and y is 0 or a positive integer.

9. The non-aqueous electrolyte for secondary batteries according to claim 8, wherein, in the lithium salt having an oxalato complex as an anion, the transition metal M is boron or phosphorus.

10. The non-aqueous electrolyte for secondary batteries according to claim 7, wherein the lithium salt having an oxalato complex as an anion is lithium bis(oxalato)borate (Li[B (C₂O₄)₂]).

11. The non-aqueous electrolyte for secondary batteries according to claim 7, wherein another lithium salt is contained as the solute in the non-aqueous electrolyte in addition to the lithium salt having an oxalato complex as an anion.

12. The non-aqueous electrolyte for secondary batteries according to claim 7, wherein the non-aqueous electrolyte contains vinylene carbonate.

13. A non-aqueous electrolyte secondary battery comprising: a positive electrode, a negative electrode, and a non-aqueous electrolyte, wherein the non-aqueous electrolyte comprises a phosphoric ester compound and, as a solute of the non-aqueous electrolyte, a lithium salt having an oxalato complex as an anion.

14. The non-aqueous electrolyte secondary battery according to claim 13, wherein the lithium salt having an oxalato complex as an anion is represented by the chemical formula Li[M(C₂O₄)ₙR_{y}], where M is an element selected from transition metals, group IIIb elements, group IVb elements, and group Vb elements of the periodic table, R is a group selected from halogens, alkyl groups, and halogen-substituted alkyl groups, x is a positive integer, and y is 0 or a positive integer.

15. The non-aqueous electrolyte secondary battery according to claim 14, wherein, in the lithium salt having an oxalato complex as an anion, the transition metal M is boron or phosphorus.

16. The non-aqueous electrolyte secondary battery according to claim 13, wherein the lithium salt having an oxalato complex as an anion is lithium bis(oxalato)borate (Li[B(C₂O₄)₂]).

17. The non-aqueous electrolyte secondary battery according to claim 13, wherein another lithium salt is contained as the solute in the non-aqueous electrolyte in addition to the lithium salt having an oxalato complex as an anion.

18. The non-aqueous electrolyte secondary battery according to claim 13, wherein the non-aqueous electrolyte contains vinylene carbonate.

19. The non-aqueous electrolyte secondary battery according to claim 13, wherein the lithium salt having an oxalato complex as an anion is contained at a concentration of 0.01 to 0.2 mol/L with respect to the solvent.

20. The non-aqueous electrolyte secondary battery according to claim 13, wherein the negative electrode comprises a carbon material having a R_{A} value (I_{A}/I_{G}) of 0.05 to 0.40 as measured by laser Raman spectroscopy using an argon ion laser having a wavelength of 514.5 nm, the R_{A} value (I_{A}/I_{G}) being obtained by separating a peak PD in the vicinity of 1360 cm⁻¹ into a broad peak PA having a half-width of 100 cm⁻¹ or greater and a peak P_{G} having a half-width of less than 100 cm⁻¹ and calculating the ratio of a peak intensity (I_{A}) of the broad peak PA having a half-width of 100 cm⁻¹ or greater to a peak intensity (I_{G}) of a peak P_{G} in the vicinity of 1580 cm⁻¹.
